(19) United States
(12) Patent Application Publication
(10) Pub. No.: US 2013/0047271 A1
(43) Pub. Date: Feb. 21, 2013

(54) Author Authorization of Electronic Works

(71) Applicant: Ding-Yuan Tang, Pleasanton, CA (US)

(72) Inventor: Ding-Yuan Tang, Pleasanton, CA (US)

(21) Appl. No.: 13/214,133

(22) Filed: Aug. 19, 2011

(51) Int. Cl. G06F 21/24

(52) U.S. Cl. 726/30

(57) ABSTRACT

Described is a system, device and method for granting rights or authorizing access to or delivery of a second, subsequent or other electronic copy of an author's work to consumers and others who have previously purchased a copy of the same or other author's work. The second copy of the work is for use on or through a consumer device such as a second consumer device that is also owned by the consumer who purchased or leased a first copy of the first work. An authentication credential or proof of purchase provides the system a means to determine if authorization may be granted for an electronic copy of an author's work.

### FIELD

The present invention relates generally to systems, devices and methods for authors, artists, musicians and other creators to authorize use or grant permission for acquiring and using an electronic copy of their creative works upon receiving a proof of purchase of a first copy of their works.

### BACKGROUND

Copyright is a form of legal protection grounded in the U.S. Constitution for “original works of authorship” including literary, dramatic, musical and artistic works, to name a few. The 1976 U.S. Copyright Act generally gives the owner of copyright an exclusive right to authorize others at least to reproduce or copy the work, prepare derivative works based upon the original work, distribute copies of the work to the public by sale or other means, and display the work publicly. These rights may be contracted away.

Recently, authors, artists, musicians and other creators of copyrightable works (hereinafter “authors”) have been given ever-increased ease and means for creating and selling and licensing copies of their works in the form of electronic copies. However, even highly successful and highly recognized authors are limited by heavy restrictions by producers, distributors, publishers and other intermediaries. These entities frequently function as a barrier between an author and her fans and consumers of her works. For every thousand copies of a work sold or licensed, an author does not yield or net one thousand contacts. In the digital age, it has become increasingly feasible for authors to directly reach their fans and consumers. The producers, distributors, publishers and other intermediaries end up the beneficiaries and points of contact when consumers and fans express interest in purchasing works including subsequent works and related goods and services. Feedback and reviews are often left with and inure to the benefit of the producers, distributors, publishers and other intermediaries. While fan clubs provide some outlet to fans and consumers to more directly contact and interact with authors, improvement in the situation is highly possible.

Another concern has been unauthorized copying of electronic works of authors. While digital rights management (DRM) systems have been created to reduce or discourage theft of digital works, DRM systems in turn have caused serious barriers for fans and consumers to fully enjoy an authorized electronic copy of a work. One of these barriers is the loss of rights to access electronic copies of works. In the case of music, if a seller of DRM-protected music files goes out of business, there is a risk that a user would lose access to his music such as through the loss of a record of purchase of the music files. While there may be other distributors or purveyors of these same music files, these other non-affiliated purveyors are under no obligation to recognize a previous purchase by the user. In such a case, a user would have no other recourse but to re-purchase copies of the lost music files, especially if the non-affiliated purveyors had their own, unrelated DRM protection scheme.

Examples of excessively controlled DRM systems are aplenty. For example, one of the (currently) most popular electronic book readers uses a strong, proprietary DRM system. Users are required to use a proprietary software application to access and consume a copy of an electronic work. While end user demand has caused some retailers of electronic works to loosen restrictions on the number of copies that may be made of an electronic work authorized by a single purchase, consumers are locked into a single point of access for “sharing” or acquiring a second electronic copy of the work. Sometimes, the particular proprietary software is not available for a particular electronic device—a second consumer device on which a same user would like to consume a given work. Further, consumers can be locked into a single vendor for a particular device. Sometimes a work is not available through all retailers and thus a consumer is not able to acquire and consume works from all authors of interest on a particular device.

Other times, even if the proprietary software is available for a particular hardware platform, the proprietary software does not have all of the same features as a version for a preferred or proprietary hardware platform. If a proprietary software from a first vendor works best for a consumer's first device, and a second proprietary software from a second vendor works best for a consumer's second consumer device, a consumer is out of luck. Such a consumer is never able to acquire a second copy of the electronic work for the second consumer device (without making a second purchase) because the first vendor is not capable or amenable to providing an electronic copy of the work in the proprietary format of the second vendor! Due to their closed nature, proprietary DRM systems do not allow consumers to make their own (second and subsequent) copies of works. Thus, even if a consumer were technically sophisticated, such a consumer is not free to transfer or copy their electronic works to any of their other devices. If a consumer jailbreaks or works around the DRM system, the consumer runs the risk of voiding the license agreement of the hardware and/or software vendor and thus may lose access to legitimately purchased copies of works. Closed and proprietary DRM systems are loaded with these and other restrictions. Consequently, a consumer is not free to mix and match DRM-rich and proprietary software with open software and/or hardware platforms to find a preferred combination most desirable to the consumer. Further, a consumer is not able to freely consume electronic works even after making a purchase of a copy of an electronic work.

These and other shortcomings of the current art are overcome by use of the teachings described herein.

### SUMMARY

The invention involves authors granting permission to access a second or subsequent electronic copy of an author's work to consumers and others who have previously purchased a first copy of the author's work. Permission is granted in exchange for receiving a proof of purchase.

A first copy and a second copy of an author's work are electronic copies. The first copy may be of any file format, either open or proprietary. The second copy could be of any file format—open or proprietary. The second copy of the work is for use on or through a consumer device such as a second consumer device that is also owned or controlled by the consumer who purchased or leased a first copy of the work. The consumer, through one of various methods, provides a credential (either in an automated or automatic fashion through software or user interface, or by entering a code) to show that the consumer is authorized for the second copy of the author's work.

Authors can opt-in to the system. Consumers also can opt-in to the system. Both authors and consumers can make use of the invention irrespective of typical contractual provisions. In a preferred implementation, the system is free from restrictions of any existing contractual obligations of a publisher, distributor or other actor. For example, an author could provide a second copy of her work where a consumer has purchased a first copy of her work, perhaps in a proprietary format. The second copy could be offered at a discounted price or could be offered for free. A portal or public facing entity or service may be part of the system. Alternatively, the workings of the system may be transparent to consumers and other actors including publishers, distributors and the like and may interoperate with typical sales or leasing of media. The systems, devices and methods described herein can be used for all types of works on any type of media such as music, videos, and books and other works.

This Summary introduces a selection of concepts and aspects in a simplified form that are further described below in the Detailed Description. This Summary is not intended to identify key or essential features of the claimed subject matter, nor is it intended to be used to limit the scope of the claimed subject matter.

### BRIEF DESCRIPTION OF THE DRAWINGS

The novel features believed characteristic of the subject matter are set forth in the appended claims. Throughout, like numerals refer to like parts with the first digit of each numeral generally referring to the figure which first illustrates the particular part. The subject matter, as well as a preferred mode of use, are best understood by reference to the following Detailed Description of illustrative implementations when read in conjunction with the accompanying drawings.

FIG. 1 is a drawing of an exemplary implementation for providing mechanisms for providing proof of purchase and granting permission for or providing access to an electronic copy of a creative work through a first or second consumer device.

FIG. 2 is a drawing of an exemplary implementation for providing mechanisms for granting permission for acquiring and using an electronic copy of a creative work through a publisher.

FIG. 3 is a drawing of an exemplary implementation for providing mechanisms for providing proof of purchase and granting permission for or providing access to an electronic copy of a creative work through a first distributor.

FIG. 4 is a drawing of an exemplary implementation for providing mechanisms for providing proof of purchase and granting permission for or providing access to an electronic copy of a creative work through a second distributor.

FIG. 5 is a drawing of an exemplary implementation for providing mechanisms for providing proof of purchase and granting permission for or providing access to an electronic copy of a creative work through an authorization service.

FIG. 6 is a drawing of an exemplary implementation for providing mechanisms for providing proof of purchase and granting permission for or providing access to an electronic copy of a creative work through one or more application programming interfaces.

FIG. 7 is a flowchart illustrating various exemplary implementations of methods for granting permission for acquiring and using an electronic copy of a creative work on a second or subsequent consumer device.

FIG. 8 is a diagram of an exemplary computer system or hardware and/or software with which a consumer may seek author authorization for use of a second or subsequent or additional copy of an electronic work.

### DETAILED DESCRIPTION

While the invention is described below with respect to one or more exemplary or preferred embodiments and implementations, other embodiments and implementations are possible. The concepts disclosed herein apply equally to other systems, devices and methods for authors, artists, musicians and other creators to receive proof of purchase of a copy of their works, and to authorize use or grant permission for acquiring and using an electronic copy of their creative works. Such authorization may be granted or facilitated through an authorization service. Furthermore, the concepts applied herein apply more generally to authorizations and permissions associated with electronic works. The various aspects of the disclosure are made with reference to the accompanying figures.

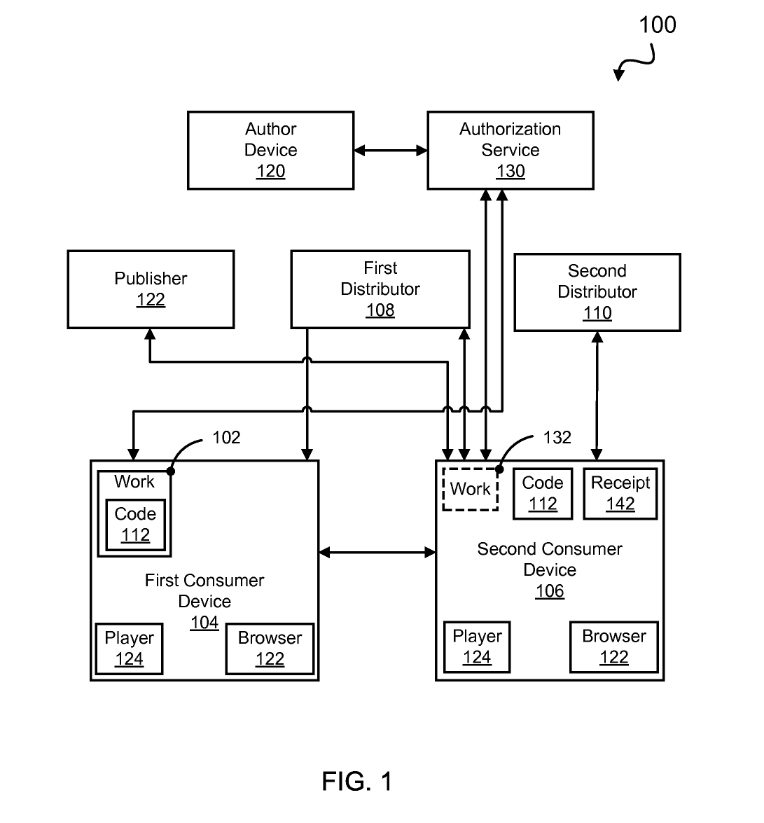

FIG. 1 is a drawing of an exemplary implementation 100 for providing mechanisms for receiving and storing a separate or independent proof of purchase of an electronic copy of an electronic copy of an author's work 102 and for authorizing use of or granting permission for acquiring and using an electronic copy of a creative or author's work 102. With permission, a work 102 may be provided to or made available or may be experienced through a first consumer device 104 or a second consumer device 106.

With reference to FIG. 1, in an exemplary scenario, previously, the consumer acquired (e.g., purchased, leased, downloaded) a first (authorized) copy of the electronic work 102 from a first distributor 108 and a copy of the electronic work 102 was placed onto the first consumer device 104 or is accessible by the first consumer device 104 (e.g. streamed or streamable or downloadable to the first consumer device 104). The electronic work 102 may be in a proprietary format that is only modifiable or known by the first distributor 108, or in a format that is only accessible by the software, hardware or software and hardware of the first consumer device 104. In this scenario, the first consumer device 104 is sold by, affiliated with or otherwise interoperable with the goods and services of the first distributor 108.

In the exemplary scenario, the authorization service 130 provides a service or mechanism to users (not shown) that has not previously been made available. Through the first consumer device 104 or through some other means (such as those described herein), a user sends or communicates a proof of purchase to the authorization service 130. The proof of purchase (not shown) may be any number of things including a code 112, a copy of a receipt 142 or a portion of the receipt 142, etc. The code 112 may be valid for a limited time or longer, and may be tied, identified with or trackable to a particular work or collection of works. The code 112 may include information that may allow tracking back to a particular publisher, distributor, or author. In a preferred implementation, the proof of purchase is a code 112, is in an electronic form and may be transmitted by any conventionally known mechanism to the authorization service 130 or a mechanism as described herein. The mechanism may be initiated by the user, the first consumer device 104, the second consumer device 106, the publisher 122, the first distributor 108, the second distributor 110, or the authorization service 130. In a preferred implementation, the proof of purchase is capable of being connected or tied to a particular user or group of users (e.g., family members, household members), or to a single electronic account such as a unique or semi-unique (account) number, email account, computer account, consumer device account, etc.

The authorization service 130 may be created and operated independently of the first distributor 108. In the event that the first distributor 108 went out of business, changed its use policy, expired a user's authorization to consume the work 102, etc., a user would have recourse to the authorization service 130. Thus, at some future time, if a user desired to seek an author's permission to access a second copy of a work, the author and the user would have access to a record (provided by the authorization service 130) of a previous right granted to user of the first device 104.

Turning again to FIG. 1, the authorization service 130 may accept any number of means for showing proof of purchase. The code 112 is shown as located in the work 102, but may be located in or derived from the work 102, or from one or more locations or components described in the implementation 100. For example, the code 112 may be derived from the work 102, or may be stored in a copy of the work 102—either in an encrypted or non-encrypted form, or in a human-readable format or machine-readable-only format. Alternatively, the code 112 may be found on a receipt provided by the first distributor 108. In a further alternative embodiment, the proof of purchase is merely a copy of a conventional receipt or other conventional proof of purchase from the first distributor 108 (e.g., an electronic receipt, a picture of a paper receipt, an electronic picture of a product tied to the work 102). The code 112 may be a short or long series of digits, characters or phrase found on a receipt 142.

The authorization service 130 also receives some identifying information for tying the work 102 to a particular first consumer device 104 or to a particular user. For example, a user may provide an email address, a name, a cellular telephone number, and/or other bit of information to associate with the proof of purchase. Alternatively, in response to receiving a proof of purchase, the authorization service 130 may provide one or more portions of identifying information (not shown in FIG. 1) for the user or the first consumer device 104 to remember or store.

In practice, the delivery mechanism or authorization mechanism would be as easy as possible. For example, a software application operating on the first consumer device 104 prompts a user to inquire whether the user would like to furnish a proof of purchase to the authorization service 130. The prompt may come upon a new work 102 being placed or transferred to the first consumer device 104 (e.g., download from the first distributor 108). After responding in the affirmative, the first consumer device 104 would transfer a code 112 or other proof of purchase to the authorization service 130; the first consumer device 104 could also transfer an identifier associated with the first consumer device 104 to the authorization service 130 so that the authorization service 130 could tie a particular work 102 to a particular first consumer device 104 (and accordingly or presumably to a particular user).

Alternatively, a code 112 (such as found in an electronic receipt 142 or on a printed paper receipt) could be entered through a Web form and a Web browser 122 operating on any device or operating on the first consumer device 104. In this implementation, a user would enter an email address or other identifier to be stored with or associated with the code 112 to tie a particular work 102 (or purchase) to a particular user. In yet another implementation, a user could send an SMS text message (including a code 112) from her cellular telephone by which to provide a proof of purchase.

An author (not shown) through an author device 120 could communicate with the authorization service 130 that, in turn, could offer to an author, identifying information that could be used to reach his fans, users or consumers of his work 102. This mechanism is in contrast to a typical fan Web site which has no mechanism to determine whether a user of a first consumer device 104 has purchased a copy a particular work 102. Armed with the identifying information, an author could incentivize his paying fans to purchase other works and related and allied goods, or could reward his paying fans with direct interaction or free goods or services. For example, an author could distribute a discount code (not shown) to cellular phones and consumer devices where the discount code would be effective to reduce the price of another work of the author. The consumer or device user would be free to use the discount code with any purveyor of the author's works such as a publisher 122, a first distributor 108 or a second distributor 110.

In a preferred implementation, an author could incentivize, for example, a second distributor 110 to automatically provide a proof of purchase for each consumer device or purchase of a work 102 made through the second distributor 110. In exchange, an author could agree to provide a free good or service to the consumers or users that purchase through the second distributor who cooperates with the author and authorization service 130. For example, the author could distribute to each user (such as through a first consumer device 104) a discount code that is only redeemable through the second distributor 110 and thereby incentivize subsequent purchases through the second distributor 110 instead of through a first distributor 108, where maybe the first distributor 108 does not cooperate or share information with the authorization service 130.

In a given day, consumers often consume media, information and works 102 on a variety of devices. Further, consumers upgrade and change equipment frequently. It often becomes necessary to copy or migrate works to a new or second device 106. The current invention is particularly useful when a first distributor 108 does not cooperate in allowing migration or duplication of a work 102 (available and validly purchased for a first consumer device 104) for a second consumer device 106. With the current invention, a consumer may initiate a request to acquire a second copy of a work 132 for consumption on or through the second consumer device 106.

In one implementation, and with reference to FIG. 1, the consumer uses, activates or triggers a user interface element (not shown) on the second consumer device 106. A request is then sent from the second consumer device 106 to the authorization service 130. The request queries whether the user of the second consumer device 106 has already provided to the authorization service 130 a proof of purchase for the work 102 in question. If so, an authorization (not shown in FIG. 1) is sent back to the second consumer device 106. The authorization may take any form including an alphanumeric code, an email message, an SMS text message, audio file, an encrypted token or any such data.

With the authorization, the second consumer device 106 may communicate with a publisher 122, a first distributor 108 or second distributor 110 who in turn provides or streams a second copy of a work 132 for use on the second consumer device 108. The communication may include none, some or all of the authorization. The communication may allow one or more of the publisher 122, first distributor 108 and second distributor 110 to access storage or memory of the second consumer device 106 to retrieve an indication of authorization for a second copy of the work 132. The second copy 132 may originate from one or more of the various actors.

In general, the request may go to any participating actor, and the same or another actor may then provide access to or an actual second copy of the work 132. Many of the possible mechanisms for delivery of the second copy of the work 132 for the exemplary scenario of FIG. 1 are described.

For example, after the authorization service 130 determines authorization and communicates authorization, the authorization service 130 provides access to a second copy of the work 132, streams a second copy of the work 132, or provides an actual second copy of the work 132. While the second copy 132 of the work 102 is shown residing on the second consumer device 106, the second copy 132 merely may be accessible from the second consumer device 106 piecewise across a network or may be provided with an expiration mechanism. The second copy 132 may reside in part or in full on one or more other devices, in one or more databases (not shown) or in a network-accessible location.

In the scenario shown in FIG. 1, the authorization service 130 or the second consumer device 106 may pass an initial request for the second copy 132 to another entity (e.g., first consumer device 104, first distributor 108, second distributor 110, or publisher 122). Alternatively, any of the first consumer device 104, first distributor 108, the second distributor 110, or the publisher 122 may receive a request from the second consumer device 106. In general, any of the entities or actors in FIG. 1 may respond to the request and (1) seek a determination of authorization to deliver a second copy 132 of the work 102 and (2) cause delivery or grant of access to the second copy 132 of the work 102.

In the scenario where the second consumer device 106 initiates the request, one of the entities obtains authorization and also fulfills the request for the second copy 132 of the work 102. For example, the first distributor 108 receives the request, determines if the first copy of the work 102 is authorized and then fulfills the request for a second copy 132 of the work 102 to be passed to the second consumer device 106 or for providing access to a second copy 132 of the work 102 from the second consumer device 106. In another example, the second distributor 110 receives the request, determines if the first copy of the work 102 is authorized and then fulfills the request for a second copy 132 of the work 102 to be passed to the second consumer device 106 or for providing access to a second copy 132 of the work 102 from the second consumer device 106. In yet another example, the publisher 122 receives the request, determines if the first copy of the work 102 is authorized and then fulfills the request for a second copy 132 of the work 102 to be passed to the second consumer device 106 or for providing access to a second copy 132 of the work 102 from the second consumer device 106. In other implementations, the entity that performs authentication may be a different entity other than the entity that fulfills the request for the second copy 132 of the electronic work 102. Each of the entities, though not directly shown in FIG. 1, communicates with the authorization service 130.

Through the authorization service 130, an author is able to more directly receive feedback from consumers of her works, to more directly communicate with her consumers and consumers of her works, and to more directly interact with these consumers. The mechanism(s) behind the various actors or devices may operate transparently to consumers and users of the first consumer device 104 and second consumer device 106.

In the exemplary scenario of FIG. 1, an author, through an author device 120 and authorization service 130 and receiving a proof of purchase for a work 102, has gained an ability to send and receive communications to and from the authorization service 130 without regard for the format of the work 102 or the operations of a first distributor 108. For each transaction with the authorization service 130, the authorization service 130 allows an author and/or author device 120 to track purchases of works 102, and monitor each request for a second or subsequent copy of the electronic work 102. Thus, an author (or publicist, assistant or other similar entity or person) may do any number of things to reward or incentivize a consumer for requesting or inquiring about acquiring a second or subsequent copy of the electronic work. For example, an author may offer (1) discounts on an author's other (current and future) works, (2) bonus tracks, (3) bonus chapters of an electronic book, (4) special photograph of the author, etc. Prior to the mechanisms described herein, much of the information related to transactions for a first copy of a work 102 and subsequent copies of the work has been sequestered from authors and remains exclusively in the possession of a first distributor 108.

### Alternative Authorizations

With reference to FIG. 1, there are additional and various means or mechanisms through which a second copy 132 of the electronic work 102 may be requested or authorized. For example, one of these various means is a request sent from the second consumer device 106 to the first consumer device 104. Sending the request comprises determining that a second copy 132 of the electronic work 102 is authorized. Either the first consumer device 104 or the second consumer device 106 may communicate with one or more of the other entities in the system 100 to determine such authorization. For example, the first consumer device 104 may communicate with the second consumer device 106, the first distributor 108, the second distributor 110, the publisher 122 or the authorization service 130.

The authorization process may include sending one or more codes 112 that is a part of or derived or derivable from the electronic work 102. In a preferred implementation, the code 112 is unique to the work and at least semi-unique and preferably unique to the owner of the first consumer device 104, or semi-unique or unique to an account associated with the first consumer device 104, or semi-unique or unique to the first consumer device 104 or device type. Alternatively, the code 112 may be semi-unique or unique to the purchaser of the electronic work 102. The code 112 may be derivable or extracted from the electronic work 102 such as through the use of a digest, decryption or other function or combination of functions.

Alternatively, a consumer (not shown) may trigger a request for a second copy 132 of the electronic work 102 through an Internet browser 122, a player 124, or other software or user interface. A consumer may send a request to one of the entities in the system 100 through either the first consumer device 104 or the second consumer device 106. A consumer may send an electronic photograph of a receipt or an electronic copy of a receipt 142 or a copy of a purchase confirmation email (not shown) that indicates or authenticates that a consumer has previously purchased a first copy of the electronic work 102 shown in FIG. 1 for the first consumer device 104 and that was or is currently available on or from the first consumer device 104. The electronic photograph may be sent by email, email attachment, Internet relay chat, SMS text message, proprietary or open protocol or by some other means. Preferably, the electronic photograph or image includes the code 112. Alternatively, just the code 112 is sent to one of the entities by email, email attachment, Internet relay chat, SMS text message, proprietary or open protocol or some other means. If the code 112 is sent by email, Internet relay chat or SMS text message, the code 112 is in a human readable or human enterable format. While such code 112 may be at risk for being used multiple times by unauthorized consumers, distribution of unauthorized copies may be restricted by the authentication service 130 or another entity. For example, the authentication service may make such restrictions by recording a number of uses of each code 112 and is capable of flagging or restricting subsequent or excessive requests for subsequent copies 132 of a particular electronic work 102 based on a number of times that each code 112 is used. After one of the entities receives the code 112 or a copy of the electronic photograph, a second copy 132 of the electronic work 102 is delivered or made available.

### Distributor

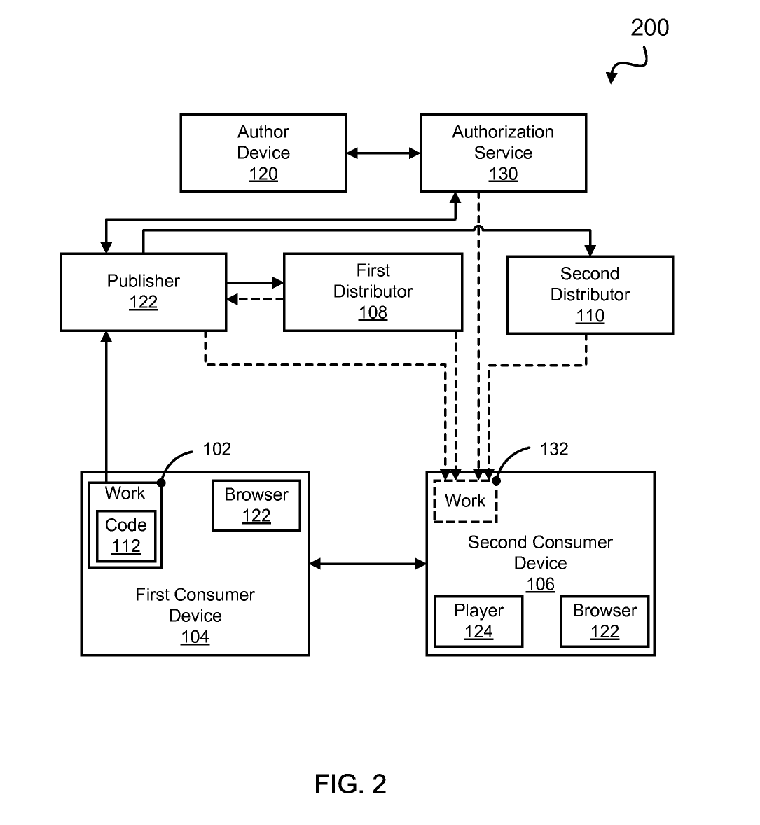

FIG. 2 is a drawing of an exemplary implementation 200 for providing mechanisms for providing a proof of purchase and, optionally, authorizing use of or granting permission for acquiring and using an electronic copy of a creative work through a publisher. With reference to FIG. 2, a first copy of an electronic work 102 is shown as residing on a first consumer device consumer device 104, but may also be merely accessible on the first consumer device 104 or otherwise consumable on the first consumer device 104. The first consumer device 104 is accessible by a consumer (not shown). In an exemplary scenario, previously, the consumer acquired (e.g., purchased, leased, downloaded) the first (authorized) copy of the electronic work 102 on the first consumer device 104 from a first distributor 108. The electronic work 102 may be in a proprietary format that is only modifiable or known by the first distributor 108, or in a format that is only accessible by the software, hardware or software and hardware of the first consumer device 104.

In the exemplary scenario, the consumer desires to provide a proof of purchase (such as to the authorization service 130) and to acquire a second copy 132 of the electronic work 102 or to transfer or otherwise access the first copy of the electronic work 102 from the second consumer device 106. In one implementation, the consumer activates or triggers a user interface element (not shown) on the first consumer device 104 to start the process of acquisition of or access to the second copy 132 of the electronic work 102. In this implementation, the first consumer device 104 communicates with one or more of the various actors to acquire the second copy 132 of the electronic work 102. The second copy 132 may originate from one or more of the various actors. Alternatively, the second copy 132 may originate from the first consumer device 104, and may be transferred either directly or indirectly from the first consumer device 104 to the second consumer device 106. Many of the possible mechanisms for the exemplary scenario of FIG. 2 are described.

For example, the first consumer device 104 communicates with a publisher 122 of the work 102. After a proof of purchase has been provided to the authorization service 130, the publisher 122 needs to determine if the first copy of the work 102 is authorized or was purchased by the user of the first consumer device 104. The publisher 122 may communicate with the first distributor 108, a second distributor 110, or the authorization service 130 to determine authorization for the first consumer device 104 to have the first copy of the work 102. In turn, the first distributor 108 or a second distributor 110 may communicate with the authorization service 130 to make the determination or to otherwise receive confirmation that the first copy of the work 102 is authorized or was previously purchased. Once the publisher 122 determines that the first distributor 108 previously authorized the first copy of the work 102 or that the first copy of the work 102 was previously purchased by the user of the first consumer device 104, then one of the actors (e.g., first distributor 108, second distributor 110, publisher 122 or authorization service 130) fulfills the request. Fulfilling the request includes delivery of a second copy 132 of the work 102 to the second consumer device 106 or includes providing access to a second copy 132 of the work 102 from the second consumer device 106. While the second copy 132 of the work 102 is shown residing on the second consumer device 106, the second copy 132 merely may be accessible from the second consumer device 106. The second copy 132 may be resident in part or in full on one or more other devices, in one or more databases (not shown) or in a network-accessible location.

In the scenario shown in FIG. 2, after authorization, the publisher 122 communicates or authorizes the first distributor 108, the second distributor 110, the authorization service 130, or (a mechanism of) itself (the publisher 122) to deliver or grant access to the second copy 132 of the work to the second consumer device 106. In the authorization and delivery scenario where the publisher 122 determines authorization through the authorization service 130 (FIG. 2), the authorization service 130 communicates directly or indirectly with a corresponding author device 120 as to who and what requested a second copy 132 of the work 102. Through this mechanism, an author is able to more directly receive feedback from consumers of her works, to more directly communicate with her consumers and consumers of her works, and to more directly interact with these consumers. The mechanism(s) behind the various actors or devices may operate transparently to consumers and users of the first consumer device 104 and second consumer device 106.

In the scenario shown in FIG. 2, the publisher 122 may pass an initial request for the second copy 132 to another entity (e.g., first distributor 108, second distributor 110, or authorization service 130). The another entity may then act in the place of the distributor 122 to respond to the request and (1) seek a determination of authorization to deliver a second copy 132 of the work 102 and (2) cause delivery or grant of access to the second copy 132 of the work 102. One of these three entities obtains authorization and then fulfills the request for the second copy 132 of the work 102. For example, the first distributor 108 determines if the first copy of the work 102 is authorized and then fulfills the request for a second copy 132 of the work 102 to be passed to the second consumer device 106 or for providing access to a second copy 132 of the work 102 from the second consumer device 106. In another example, the second distributor 110 determines if the first copy of the work 102 is authorized and then fulfills the request for a second copy 132 of the work 102 to be passed to the second consumer device 106 or for providing access to a second copy 132 of the work 102 from the second consumer device 106. In yet another example, the authorization service 130 determines if the first copy of the work 102 is authorized and then fulfills the request for a second copy 132 of the work 102 to be passed to the second consumer device 106 or for providing access to a second copy 132 of the work 102 from the second consumer device 106. When the publisher 122 passes the initial request for the second copy 132 to another entity, the publisher 122 communicates information related to the initial request to the authorization service 130. In other implementations, the entity that performs authentication may be a different entity than the entity that fulfills the request for the second copy 132 of the electronic work 102. Through this mechanism, an author is able to more directly receive feedback from consumers of her works, to more directly communicate with her consumers and consumers of her works, and to more directly interact with these consumers. The mechanism(s) behind the various actors or devices may operate transparently to consumers and users of the first consumer device 104 and second consumer device 106.

In the exemplary scenario of FIG. 2, an author, through an author device 120 and authorization service 130, has gained an ability to send and receive communications to and from the authorization service 130. For each transaction with the authorization service 130, the authorization service 130 allows an author and/or author device 120 to track and monitor each purchase of a first copy of a work 102 and each request for a second or subsequent copy 132 of the electronic work 102. Thus, an author (or publicist, assistant or other similar entity or person) may do any number of things to reward or incentivize a consumer for providing proof of purchase and requesting or inquiring about acquiring a second or subsequent copy of the electronic work. For example, an author may offer (1) discounts on an author's other works, (2) bonus tracks, (3) bonus chapters of an electronic book, (4) special photograph of the author, etc. Prior to the mechanisms described herein, much of the information related to transactions for a first copy of a work 102 and subsequent copies of the work has been sequestered from authors and remains exclusively in the possession of a first distributor 108.

### First Distributor

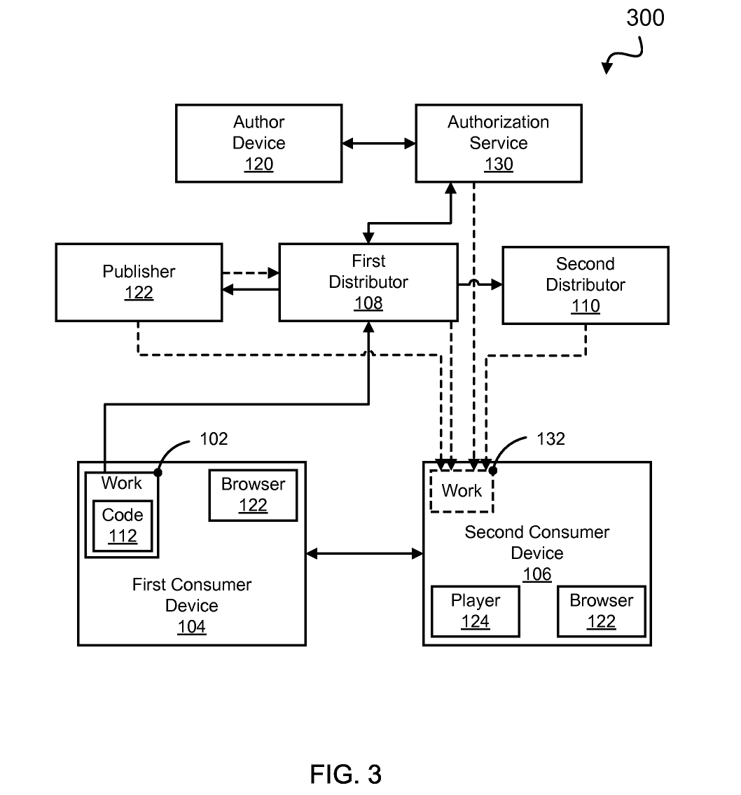

FIG. 3 is a drawing of an exemplary implementation 300 for providing mechanisms for providing a proof of purchase to an authorization service 130, and authorizing use of or granting permission for acquiring and using an electronic copy of a creative work, through a first distributor 108. With reference to FIG. 3, a first copy of an electronic work 102 is shown as residing on a first consumer device consumer device 104, but may also be merely accessible on the first consumer device 104 or otherwise consumable on the first consumer device 104. The first consumer device 104 is accessible by a consumer (not shown). In an exemplary scenario, previously, the consumer acquired (e.g., purchased, leased, downloaded) the first (authorized) copy of the electronic work 102 on the first consumer device 104 from a first distributor 108. The electronic work 102 may be in a proprietary format that is only modifiable or known by the first distributor 108, or in a format that is only accessible by the software, hardware or software and hardware of the first consumer device 104.

In the exemplary scenario, the consumer desires to provide a proof of purchase to the authorization service 130 and, optionally, acquire a second copy 132 of the electronic work 102 or to transfer or otherwise access the first copy of the electronic work 102 from the second consumer device 106. In one implementation, the consumer activates or triggers a user interface element (not shown) on the first consumer device 104 to start the process of providing a proof of purchase to the authorization service 130 and acquire or access the second copy 132 of the electronic work 102. In this implementation, the first consumer device 104 communicates with one or more of the various actors. The second copy 132 may originate from one or more of the various actors. Several of various possible mechanisms for the exemplary scenario of FIG. 3 are described.

For example, the first consumer device 104 communicates with a first distributor 108 of the work 102. The first distributor may have been the entity that passed the proof of purchase to the authorization service 130. After a proof of purchase has been provided to the authorization service 130, upon receiving a request from the first consumer device 104, the first distributor 108 needs to determine if the first copy of the work 102 is authorized. The first distributor 108 may communicate with the publisher 122, a second distributor 110, or an authorization service 130 to determine authorization for the first consumer device 104 to have the first copy of the work 102. Once the first distributor 108 determines that the first copy of the work 102 is authorized, then one of the actors (e.g., first distributor 108, second distributor 110, publisher 122 or authorization service 130) fulfills the request. Fulfilling the request includes delivery of a second copy 132 of the work 102 to the second consumer device 106 or includes providing access to a second copy 132 of the work 102 from the second consumer device 106. While the second copy 132 of the work 102 is shown residing on the second consumer device 106, the second copy 132 merely may be accessible from the second consumer device 106. The second copy 132 may be resident in part or in full on one or more other devices, in one or more databases (not shown) or in a network-accessible location.

In the scenario shown in FIG. 3, after authorization, the first distributor 108 communicates or authorizes the publisher 122, the second distributor 110, the authorization service 130, or (a mechanism of) itself (the first distributor 108) to deliver or grant access to the second copy 132 of the work to the second consumer device 106. In the authorization and delivery scenario where the first distributor 108 determines authorization through the authorization service 130, the authorization service 130 communicates directly or indirectly with a corresponding author device 120 as to who and what (device, etc.) delivered a proof of purchase for the work 102 and who and what requested a second copy 132 of the work 102. Through this mechanism, an author is able to more directly receive feedback from consumers of her works, to more directly communicate with her consumers and consumers of her works, and to more directly interact with these consumers without regard for the first distributor 108. The mechanism(s) behind the various actors or devices may operate transparently to consumers and users of the first consumer device 104 and second consumer device 106.

In the scenario shown in FIG. 3, the first distributor 108 may pass the proof of purchase and an initial request for the second copy 132 to another entity (e.g., publisher 122, second distributor 110, or authorization service 130). The another entity may then act in the place of the first distributor 108 to respond to the request to deliver the proof of purchase and (1) seek a determination of authorization to deliver a second copy 132 of the work 102 and (2) cause delivery or grant of access to the second copy 132 of the work 102. One of these three entities delivers the proof of purchase and obtains authorization and then fulfills the request for the second copy 132 of the work 102. For example, the publisher 122 delivers the proof of purchase and determines if the first copy of the work 102 is authorized and then fulfills the request for a second copy 132 of the work 102 to be passed to the second consumer device 106 or for providing access to a second copy 132 of the work 102 from the second consumer device 106. In another example, the second distributor 110 delivers the proof of purchase and determines if the first copy of the work 102 is authorized and then fulfills the request for a second copy 132 of the work 102 to be passed to the second consumer device 106 or for providing access to a second copy 132 of the work 102 from the second consumer device 106. In yet another example, the authorization service 130 receives the proof of purchase from either the first consumer device 104 or the second consumer device 106 and determines if the first copy of the work 102 is authorized and then fulfills the request for a second copy 132 of the work 102 to be passed to the second consumer device 106 or for providing access to a second copy 132 of the work 102 from the second consumer device 106. When the first distributor 108 passes the initial request for the second copy 132 to another entity, the first distributor 108 communicates information related to the initial request to the authorization service 130. In other implementations, the entity that performs authentication may be a different entity than the entity that fulfills the request for the second copy 132 of the electronic work 102. Through this mechanism, an author is able to more directly receive feedback from consumers of her works, to more directly communicate with her consumers and consumers of her works, and to more directly interact with these consumers. The mechanism(s) behind the various actors or devices may operate transparently to consumers and users of the first consumer device 104 and second consumer device 106.

In the exemplary scenario of FIG. 3, an author, through an author device 120 and authorization service 130, has gained an ability to send and receive communications to and from the authorization service 130. For each transaction with the authorization service 130, the authorization service 130 allows an author and/or author device 120 to track and monitor each purchase of a work 102 and each request for a second or subsequent copy of the electronic work 102. Thus, an author (or publicist, assistant or other similar entity or person) may do any number of things to reward or incentivize a consumer for requesting or inquiring about acquiring a second or subsequent copy of the electronic work. For example, an author may offer (1) discounts on an author's other works, (2) bonus tracks, (3) bonus chapters of an electronic book, (4) special photograph of the author, etc. Prior to the mechanisms described herein, much of the information related to transactions for a first copy of a work 102 and subsequent copies of the work has been sequestered from authors and remains exclusively in the possession of a first distributor 108.

### Second Distributor

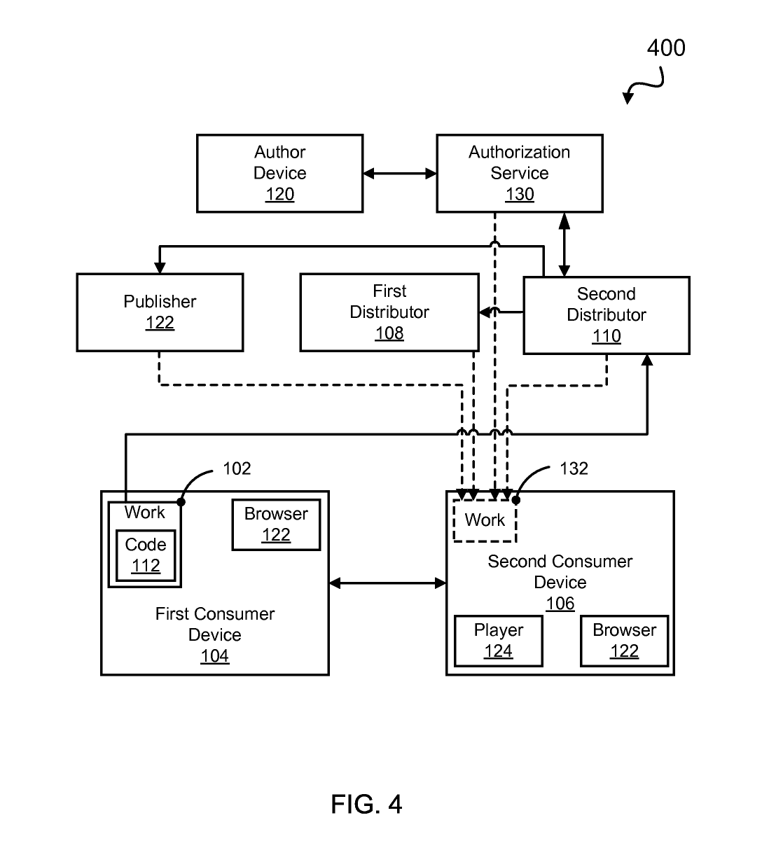

FIG. 4 is a drawing of an exemplary implementation 400 for providing mechanisms for providing a proof of purchase to an authorization service 130, and authorizing use of or granting permission for acquiring and using an electronic copy of a creative work, through a second distributor 110. With reference to FIG. 4, a first copy of an electronic work 102 is shown as residing on a first consumer device consumer device 104, but may also be merely accessible on the first consumer device 104 or otherwise consumable on the first consumer device 104. The first consumer device 104 is accessible by a consumer (not shown). In an exemplary scenario, previously, the consumer acquired (e.g., purchased, leased, downloaded) the first (authorized) copy of the electronic work 102 on the first consumer device 104 from a first distributor 108. The electronic work 102 may be in a proprietary format that is only modifiable or known by the first distributor 108, or in a format that is only accessible by the software, hardware or software and hardware of the first consumer device 104.

In the exemplary scenario, the consumer desires to provide a proof of purchase of a work 102 and acquire a second copy 132 of the electronic work 102 or to transfer or otherwise access the first copy of the electronic work 102 from the second consumer device 106. In one implementation, the consumer activates or triggers a user interface element (not shown) on the first consumer device 104 to start the process of sending a proof of purchase and the process of acquisition of or access to the second copy 132 of the electronic work 102. In this implementation, the first consumer device 104 communicates with one or more of the various actors to provide the proof of purchase and acquire the second copy 132 of the electronic work 102. The proof of purchase and second copy 132 of the work 102 may originate from one or more of the various actors from the perspective of the authorization service 130. Many of the possible mechanisms for the exemplary scenario of FIG. 4 are described.

For example, the first consumer device 104 communicates with a second distributor 110 of the work. The second distributor 110 needs to provide the proof of purchase and determine if the first copy of the work 102 is authorized. The second distributor 110 may communicate with the first distributor 108, the publisher 122, or an authorization service 130 to obtain a proof of purchase for the first copy of the work 102 and to determine authorization for the first consumer device 104 to have the first copy of the work 102. Once the second distributor 110 determines that the first distributor 108 previously authorized the first copy of the work 102, then one of the actors (e.g., first distributor 108, second distributor 110, publisher 122 or authorization service 130) fulfills the request for receiving and storing a proof of purchase and delivering a second copy 132 of the work 102. In a preferred implementation, the authorization service receives the proof of purchase. Fulfilling the request for a second copy 132 of the work 102 includes delivery of a second copy 132 of the work 102 to the second consumer device 106 or includes providing access to a second copy 132 of the work 102 from the second consumer device 106. While the second copy 132 of the work 102 is shown residing on the second consumer device 106, the second copy 132 merely may be accessible from the second consumer device 106. The proof of purchase and the second copy 132 may be resident in part or in full on one or more other devices, in one or more databases (not shown) or in a network-accessible location.

In the scenario shown in FIG. 4, after delivery of the proof of purchase and determination of authorization, the second distributor 110 communicates or authorizes the first distributor 108, the publisher 122, the authorization service 130, or (a mechanism of) itself (the second distributor 110) to deliver or grant access to the second copy 132 of the work to the second consumer device 106. In the authorization and delivery scenario where the second distributor 110 determines authorization through the authorization service 130, the authorization service 130 communicates directly or indirectly with a corresponding author device 120 as to who and what delivered a proof of purchase and who and what requested a second copy 132 of the work 102. Through this mechanism, an author is able to more directly receive feedback from consumers of her works, to more directly communicate with her consumers and consumers of her works, and to more directly interact with these consumers. The mechanism(s) behind the various actors or devices may operate transparently to consumers and users of the first consumer device 104 and second consumer device 106.

In the scenario shown in FIG. 4, the second distributor 110 may pass the proof of purchase and an initial request for the second copy 132 to another entity (e.g., first distributor 108, publisher 122, or authorization service 130). The another entity may then act in the place of the second distributor 110 to respond to deliver the proof of purchase and to fulfill the request and (1) seek a determination of authorization to deliver a second copy 132 of the work 102 and (2) cause delivery or grant of access to the second copy 132 of the work 102. One of these three entities delivers the proof of purchase and obtains authorization and then fulfills the request for the second copy 132 of the work 102. For example, the first distributor 108 delivers the proof of purchase to the authorization service 130 and determines if the first copy of the work 102 is authorized and then fulfills the request for a second copy 132 of the work 102 to be passed to the second consumer device 106 or for providing access to a second copy 132 of the work 102 from the second consumer device 106. In another example, the publisher 122 delivers the proof of purchase to the authorization service 130 and determines if the first copy of the work 102 is authorized and then fulfills the request for a second copy 132 of the work 102 to be passed to the second consumer device 106 or for providing access to a second copy 132 of the work 102 from the second consumer device 106. In yet another example, the authorization service 130 delivers the proof of purchase to the authorization service 130 and determines if the first copy of the work 102 is authorized and then fulfills the request for a second copy 132 of the work 102 to be passed to the second consumer device 106 or for providing access to a second copy 132 of the work 102 from the second consumer device 106. When the second distributor 110 passes the initial request for the second copy 132 to another entity, the second distributor 110 communicates information related to the initial request to the authorization service 130. In other implementations, the entity that performs authentication may be a different entity than the entity that fulfills the request for the second copy 132 of the electronic work 102. Through this mechanism, an author is able to more directly receive feedback from consumers of her works, to more directly communicate with her consumers and consumers of her works, and to more directly interact with these consumers. The mechanism(s) behind the various actors or devices may operate transparently to consumers and users of the first consumer device 104 and second consumer device 106.

In the exemplary scenario of FIG. 4, an author, through an author device 120 and authorization service 130, has gained an ability to send and receive communications to and from the authorization service 130. For each transaction with the authorization service 130, the authorization service 130 allows an author and/or author device 120 to track and monitor each purchase of a first copy of a work 102 and each request for a second or subsequent copy of the electronic work 102. Thus, an author (or publicist, assistant or other similar entity or person) may do any number of things to reward or incentivize a consumer for providing a proof of purchase and requesting or inquiring about acquiring a second or subsequent copy of the electronic work or of a future work. For example, an author may offer (1) discounts on an author's other works, (2) bonus tracks, (3) bonus chapters of an electronic book, (4) special photograph of the author, etc. Prior to the mechanisms described herein, much of the information related to transactions for a first copy of a work 102 and subsequent copies of the work has been sequestered from authors and remains exclusively in the possession of a first distributor 108.

### Authorization Service

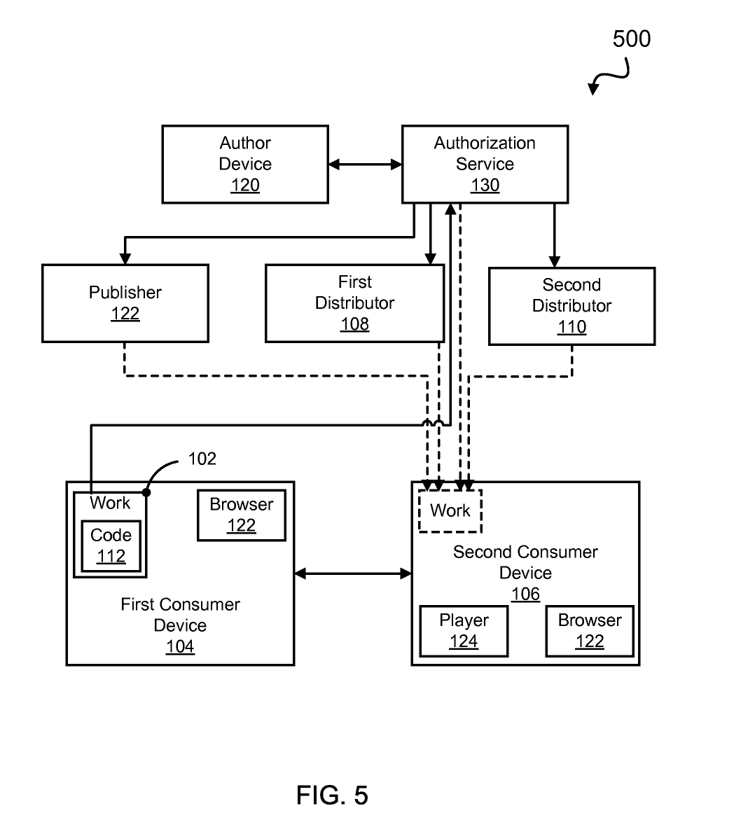

FIG. 5 is a drawing of an exemplary implementation 500 for providing mechanisms for providing a proof of purchase and authorizing use of or granting permission for acquiring and using an electronic copy of a creative work through an authorization service 130. With reference to FIG. 5, a first copy of an electronic work 102 is shown as residing on a first consumer device consumer device 104, but may also be merely accessible on the first consumer device 104 or otherwise consumable on the first consumer device 104. The first consumer device 104 is accessible by a consumer (not shown). In an exemplary scenario, previously, the consumer acquired (e.g., purchased, leased, downloaded) the first (authorized) copy of the electronic work 102 on the first consumer device 104 from a first distributor 108. The electronic work 102 may be in a proprietary format that is only modifiable or known by the first distributor 108, or in a format that is only accessible by the software, hardware or software and hardware of the first consumer device 104.

In the exemplary scenario, the consumer desires to provide a proof of purchase and, optionally, acquire a second copy 132 of the electronic work 102 or to transfer or otherwise access the first copy of the electronic work 102 from the second consumer device 106. In one implementation, the consumer activates or triggers a user interface element (not shown) on the first consumer device 104 to start the process of delivery of the proof of purchase and acquisition of or access to the second copy 132 of the electronic work 102. In this implementation, the first consumer device 104 communicates with one or more of the various actors to deliver the proof of purchase and to acquire the second copy 132 of the electronic work 102. The proof of purchase and the second copy 132 may originate from one or more of the various actors. Many of the possible mechanisms for the exemplary scenario of FIG. 5 are described.

For example, the first consumer device 104 communicates with an authorization service 130. The authorization service 130 receives a proof of purchase from one or more of the actors including the first consumer device 104 and the second consumer device 106. The authorization service 130 needs to determine if the first copy of the work 102 is authorized. The authorization service 130 may communicate with the first consumer device 104, the second consumer device 106, the first distributor 108, the second distributor 110, or the publisher 122 to determine authorization for the first consumer device 104 to have the first copy of the work 102. Once the authorization service 130 determines that the first distributor 108 previously authorized the first copy of the work 102, then one of the actors (e.g., first distributor 108, second distributor 110, publisher 122 or authorization service 130) fulfills the request. Fulfilling the request includes delivery of a second copy 132 of the work 102 to the second consumer device 106 or includes providing access to a second copy 132 of the work 102 from the second consumer device 106. Delivery or access may be provided indirectly through one of the other actors. While the second copy 132 of the work 102 is shown residing on the second consumer device 106, the second copy 132 merely may be accessible from the second consumer device 106. The second copy 132 may be resident in part or in full on one or more other devices, in one or more databases (not shown) or in a network-accessible location.

In the scenario shown in FIG. 5, after receiving proof of purchase and an indication of authorization, the authorization service 130 communicates or authorizes the first consumer device 104, the first distributor 108, the second distributor 110, the publisher 122, or (a mechanism of) itself (the authorization service 130) to deliver or grant access to the second copy 132 of the work to the second consumer device 106. In the authorization and delivery scenario where the authorization service 130 determines authorization, the authorization service 130 communicates directly or indirectly with a corresponding author device 120 as to who and what delivered a proof of purchase and who and what (device, mechanism, user, etc.) requested a second copy 132 of the work 102. Through this mechanism, an author is able to more directly receive feedback from consumers of her works, to more directly communicate with her consumers and consumers of her works, and to more directly interact with these consumers. The mechanism(s) behind the various actors or devices may operate transparently to consumers and users of the first consumer device 104 and second consumer device 106.

In the scenario shown in FIG. 5, the authorization service 130 may pass the proof of purchase and/or an initial request for the second copy 132 to another entity (e.g., first distributor 108, second distributor 110, or publisher 122). The another entity may then act in the place of the authorization service 130 to respond to the proof of purchase and/or request and (1) seek a determination of authorization to deliver a second copy 132 of the work 102 and (2) cause delivery or grant of access to the second copy 132 of the work 102. One or more of the entities receives the proof of purchase, obtains authorization and then fulfills the request for the second copy 132 of the work 102. For example, the first distributor 108 receives proof of purchase and determines if the first copy of the work 102 is authorized and then fulfills the request for a second copy 132 of the work 102 to be passed to the second consumer device 106 or for providing access to a second copy 132 of the work 102 from the second consumer device 106. In another example, the second distributor 110 receives proof of purchase and determines if the first copy of the work 102 is authorized and then fulfills the request for a second copy 132 of the work 102 to be passed to the second consumer device 106 or for providing access to a second copy 132 of the work 102 from the second consumer device 106. In yet another example, the publisher 122 receives proof of purchase and determines if the first copy of the work 102 is authorized and then fulfills the request for a second copy 132 of the work 102 to be passed to the second consumer device 106 or for providing access to a second copy 132 of the work 102 from the second consumer device 106. In other implementations, the entity that receives proof of purchase may be a different entity than the entity that performs other actions. The entity that performs authentication may be a different entity than the entity that fulfills the request for the second copy 132 of the electronic work 102. Through the authorization service 130, an author is able to more directly receive feedback from consumers of her works, to more directly communicate with her consumers and consumers of her works, and to more directly interact with these consumers. The mechanism(s) behind the various actors or devices may operate transparently to consumers and users of the first consumer device 104 and second consumer device 106.

In the exemplary scenario of FIG. 5, an author, through an author device 120 and authorization service 130, has gained an ability to send and receive communications to and from the authorization service 130. For each transaction with the authorization service 130, the authorization service 130 allows an author and/or author device 120 to track and monitor each proof of purchase of a work 102 and each request for a second or subsequent copy of the electronic work 102. Thus, an author (or publicist, assistant or other similar entity or person) may do any number of things to reward or incentivize a consumer for requesting or inquiring about acquiring a second or subsequent copy of the electronic work. For example, an author may offer (1) discounts on an author's other works, (2) bonus tracks, (3) bonus chapters of an electronic book, (4) special photograph of the author, etc. Prior to the mechanisms described herein, much of the information related to transactions for a first copy of a work 102 and subsequent copies of the work has been sequestered from authors and remains exclusively in the possession of a first distributor 108.

### Mechanisms

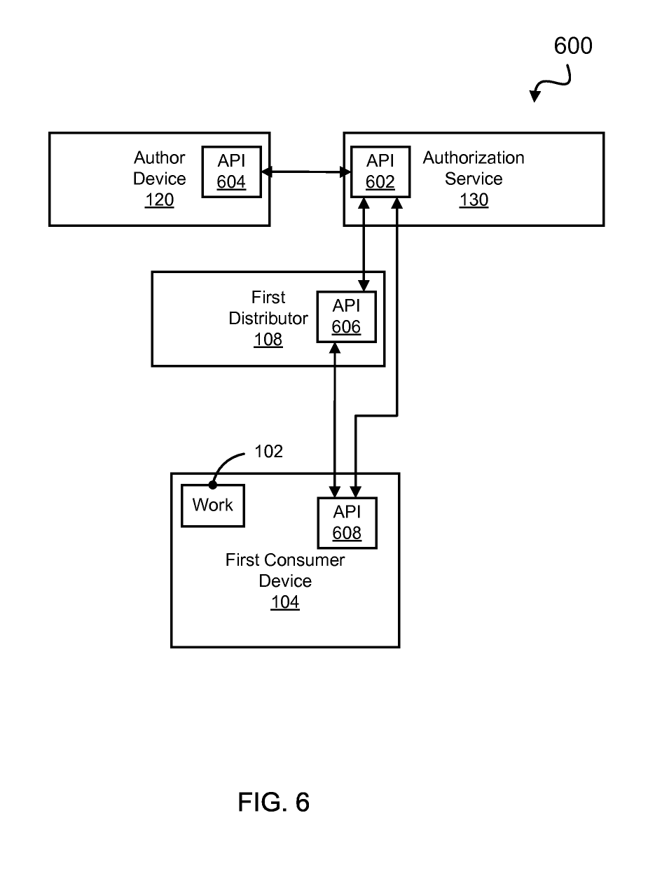

FIG. 6 is a drawing of an exemplary implementation 600 showing additional mechanisms for providing a proof of purchase of a first copy of a work and authorizing use of or granting permission for acquiring and using a second copy of a creative work through the use of application programming interfaces (API's). With reference to FIG. 6, a first consumer device 104, a first distributor 108, an author device 120 and an authorization service 130 are shown. An authorization service 130 includes one or more API's 602. The authorization service API 602 may transmit and receive information to and from other entities and with other corresponding API's. For example, the authorization service API 602 is capable of interacting with an API 604 of an author device 120, an API 606 of a first distributor 108, and an API 608 of a first consumer device 104. When a consumer requests a second copy of the electronic work 102, the various devices and entities shown in FIG. 6 may communication with each other through their respective API's. These API's may be synchronous or asynchronous. These API's may operate in a peer-to-peer fashion, in a client-server fashion, or other fashion. The API's may enable the various entities to communicate transparently and with little or no input from a consumer. Other devices and entities in the other figures may also have or use an API of their own.

### Methods

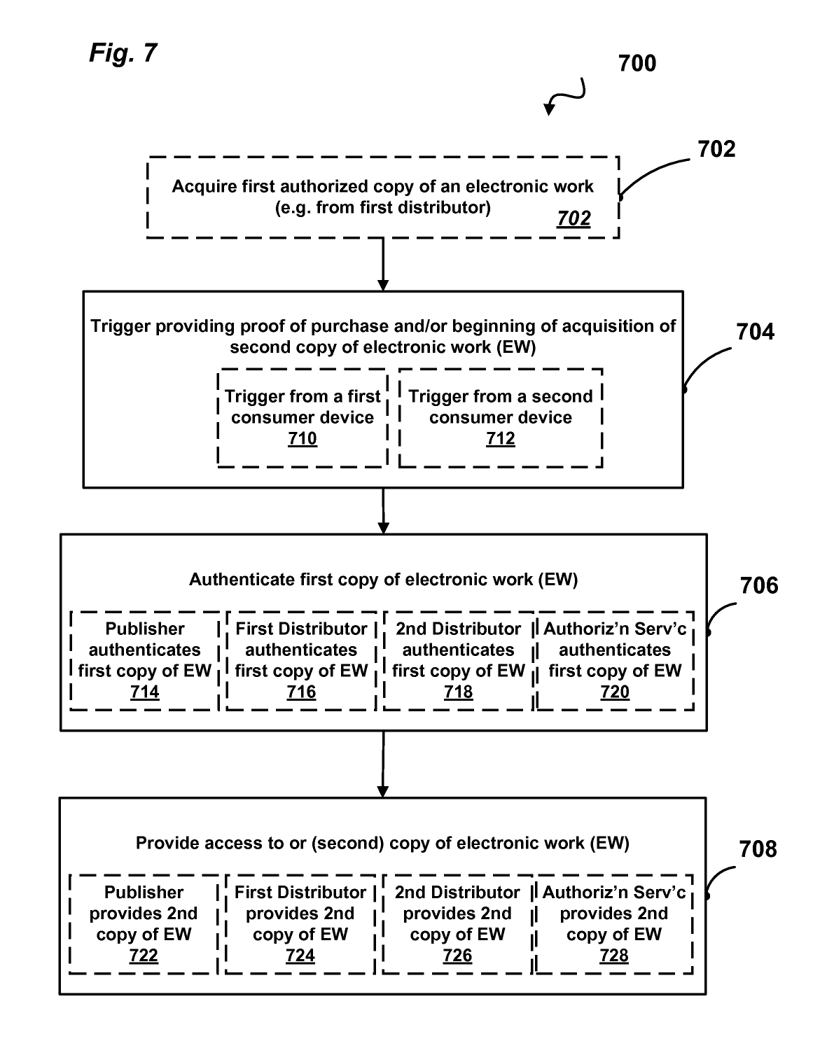

FIG. 7 is a flowchart showing an exemplary method for providing a proof of purchase to an authorization service or other third party entity, and authorizing use of or granting permission for acquiring and using an electronic copy of a creative work through an authorization service. With reference to FIG. 7, previously, a consumer acquires (e.g., purchased, leased, downloaded) a first (authorized) copy of an electronic work such as to a first consumer device from a first distributor.

Next, a consumer or user provides an indicia of or an actual proof of purchase to an authorization service. The consumer may provide such directly or indirectly such as through another service or entity. The consumer may initiate delivery of proof of purchase through or from a first consumer device (the device on which the consumer consumes a first copy of a work) or from a second or other consumer device. The proof of purchase initially may resident in part or in full on the first consumer device or on one or more other devices, actors, in one or more databases (not shown) or in a network-accessible location.

Subsequently or simultaneously, the consumer may activate or trigger a beginning to acquisition of or access to a second copy of the electronic work. For example, a first consumer device communicates with one or more of the various actors in the system (e.g., an authorization service). One of the actors, e.g. the authorization service, needs to determine if the first copy of the electronic work is authorized. The actor seeking authorization may communicate with another of the actors to determine an answer to the authorization question. When the first copy of the electronic work is determined to be authorized, the same or one or more of the other actors (e.g., first distributor, second distributor, publisher or authorization service) fulfills the request. Fulfilling the request includes delivery of or granting access to a second copy of the electronic work. The second copy may be initially resident in part or in full on one or more other devices, actors, in one or more databases (not shown) or in a network-accessible location.

### Benefits

With an availability of an authorization service 130 as described herein, authors 120 may offer benefits not previously available to consumers that have a first copy of an electronic work. One such benefit, in exchange for providing a proof of purchase, is providing a second copy 132 of the electronic work when no second copy is otherwise available or authorized by a first distributor 108. The second copy 132 may be offered in a format that is compatible with a second consumer device 106 such as one that is tied to or otherwise interacts with a second distributor 110. Such second consumer device may be open and support a variety of formats for works, or may only support proprietary file formats that are under the control or direction of the first distributor 108 or the second distributor 110. With the availability of an authorization service 130 as described herein, an author may negotiate and require a first distributor 108, a second distributor 110 or both a first distributor 108 and a second distributor 110 to authorize interaction of an authorization service 130 with the services offered by these distributors. These benefits may come at a cost such as providing a proof of purchase or requiring consumers to register with the authorization service 130 prior to interacting with one or more of the actors in system 100 such as with the authorization service 130. These benefits may require an extra fee or higher price for a first copy of an electronic work from a first distributor 108. Alternatively, the cost may be born by authors or operators of an authorization service 130 and the second copy of the electronic work may be offered for free. Another benefit may be discounts to future works or exclusive access to future works by an author. In yet another implementation, a second copy may require an additional fee or price, but may be offered at a discounted price relative to the price of the first copy of the electronic work.

If the second copy of the electronic work is offered or delivered by the authorization service, an author may stand to profit from an additional stream of revenue not previously available by exclusively working through a first distributor assuming, as needed, the author reserved a right to do so when entering a contract between the author and the first distributor. Authors may be able to offer electronic copies of their works in formats that are unavailable through, for example, a first distributor. In an exemplary scenario, a customer may be frustrated that a particular work may not be available in a particular file format (e.g., only available in a proprietary Amazon® Kindle® format). The customer may be able to acquire the particular work in a desired file format by first purchasing a first copy of an electronic work in a first file format, and then providing proof of purchase from the first distributor to an authorization service. In turn, this consumer receives a “second” and useable copy of the electronic work in the desired file format.

In an exemplary implementation, authors would opt-in to the system. Further, authors could require as part of their contracts with a first distributor, a second distributor and/or a publisher that these respective parties provide access to data derived from the sale and interaction with consumer devices with their respective systems. The authors would be able to access the data through an authorization service as described herein and through the use of an author device as described herein. The implementations described herein could be used with any media including, for example, music, podcasts, lectures, educational materials, medical and scientific research, news stories, videos, graphical and visual works, and text-based works.

### Exemplary Device

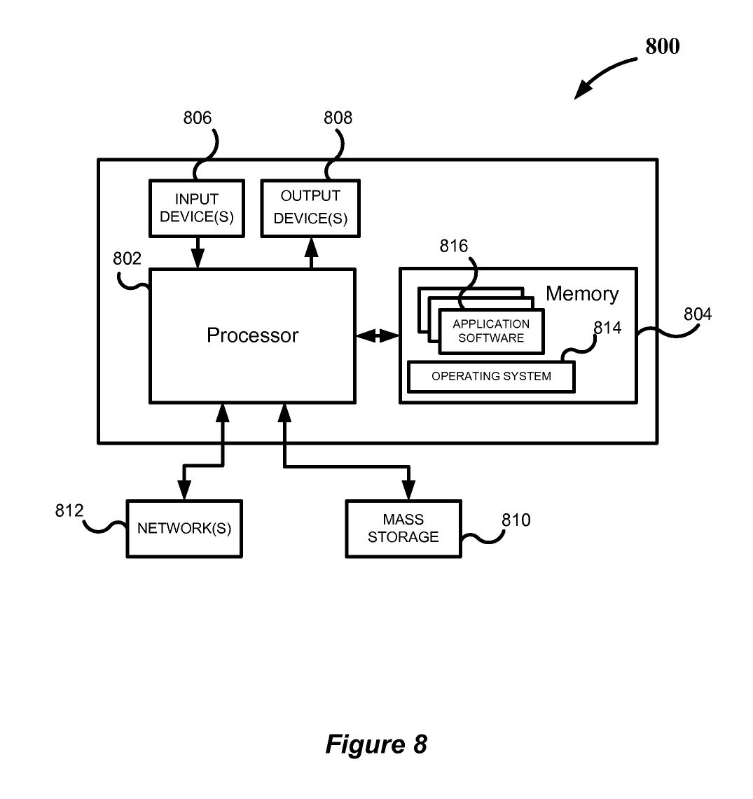

FIG. 8 is a diagram of an exemplary computer system or hardware and/or software 800 with which a consumer may seek author authorization for use of a second or subsequent or additional copy of an electronic work. Referring to FIG. 8, the hardware 800 typically includes at least one processor 802 coupled to a memory 804. The processor 802 may represent one or more processors (e.g. microprocessors), and the memory 804 may represent random access memory (RAM) devices comprising a main storage of the hardware 800, as well as any supplemental levels of memory, e.g., cache memories, non-volatile or back-up memories (e.g. programmable or flash memories), read-only memories, etc. In addition, the memory 804 may be considered to include memory storage physically located elsewhere in the hardware 800, e.g. any cache memory in the processor 802 as well as any storage capacity used as a virtual memory, e.g., as stored on a mass storage device 810.

The hardware 800 also typically receives a number of inputs and outputs for communicating information externally. For interface with a user or operator, the hardware 800 may include one or more user input devices 806 (e.g., a keyboard, a mouse, imaging device, scanner) and a one or more output devices 808 (e.g., a Liquid Crystal Display (LCD) panel, a sound playback device (speaker)).

For additional storage, the hardware 800 may also include one or more mass storage devices 810, e.g., a floppy or other removable disk drive, a hard disk drive, a Direct Access Storage Device (DASD), an optical drive (e.g. a Compact Disk (CD) drive, a Digital Versatile Disk (DVD) drive) and/or a tape drive, among others. Furthermore, the hardware 800 may include an interface with one or more networks 812 (e.g., a local area network (LAN), a wide area network (WAN), a wireless network, a cellular network (not shown) and/or the Internet among others including all of the devices or equipment necessary to carry out network communication) to permit the communication of information with other computers or devices coupled to the networks. It should be appreciated that the hardware 800 typically includes suitable analog and/or digital interfaces between the processor 802 and each of the components 804, 806, 808, and 812 as is well known in the art.

The hardware 800 operates under the control of an operating system 814, and executes various computer software applications, components, programs, objects, modules, etc., to implement the techniques described above. In particular, the computer software applications may include a client application, in the case of the client user device or smart phone 302. Moreover, various applications, components, programs, objects, etc., collectively indicated by reference 816 in FIG. 8, may also execute on one or more processors in another computer coupled to the hardware 800 via a network 812, e.g. in a distributed computing environment, whereby the processing required to implement the functions of a computer program may be allocated to multiple computers over a network.

In general, the routines executed to implement the described technology may be implemented as part of an operating system or a specific application, component, program, object, module or sequence of instructions referred to as “computer programs.” The computer programs typically comprise one or more instruction sets at various times in various memory and storage devices in a computer, and that, when read and executed by one or more processors in a computer, cause the computer to perform operations necessary to execute elements involving the various aspects of the described technology. Moreover, while the technology has been described in the context of fully functioning computers and computer systems, those skilled in the art will appreciate that the various implementations are capable of being distributed as a program product in a variety of forms, and that the technology applies equally regardless of the particular type of computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD-ROMs), Digital Versatile Disks (DVDs), flash memory, etc.), among others. Another type of distribution may be implemented as Internet downloads.

Systems, devices and methods have been described for facilitating the display or use of displaying or using text and other information in a format that substantially appears as originally displayed or found on or in a medium (e.g., screen, television, paper, book, newspaper, fax, sign, photograph, magazine, etching, sculpture). Throughout, for sake of simplicity in explanation, reference is made to text and/or words. However, text and words refer generally to any information that is capable of being perceived, identified, recognized or used and may be found in or on any medium. While a smart phone is referred to herein, it is merely exemplary. It is to be understood that “smart phone” refers to any device that cannot display an actual sized representation of the menu 202 or to a device with a relatively small display (e.g., tablet, laptop, appliance).

While certain exemplary embodiments and implementations have been described and shown in the accompanying drawings, it is to be understood that such embodiments and implementations are merely illustrative and not restrictive of the broad described technology and that this technology is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure.

While the technology has been described with respect to a preferred implementation, other implementations are possible. The concepts disclosed herein apply equally to other non-described systems, devices and methods for displaying or using text (and information generally) in a format that substantially appears as originally displayed or found on or in a medium. Furthermore, the concepts applied herein apply more generally to displaying or using text and breaking adjacent text at word and other logical boundaries such as at, near or around a character or element. The technology is described below with reference to the accompanying figures.

The foregoing discussion has been presented for purposes of illustration and description. Various features from one implementation can be combined with other features from other implementations. The description is not intended to limit the technology to the form or forms disclosed herein. Consequently, variation and modification commensurate with the above teachings, within the skill and knowledge of the relevant art, are within the scope of the described technology. The implementations described herein and above are further intended to explain the best mode presently known to the inventors and to enable others skilled in the art to use the technology as such, or in other implementations, and with the various modifications required by their particular application or uses of the technology. It is intended that the appended claims be construed to include alternate implementations to the extent permitted.

I claim:

1. A method for providing an electronic copy of a first work, the method comprising:
receiving an indication of a proof of purchase of a second work;
receiving an indication of a request for access to the electronic copy of the first work;
determining whether the proof of purchase of the second work corresponds to a portion of the request for access to the electronic copy of the first work; and
sending authorization for access to the electronic copy of the first work when the determination is successful.

2. The method of claim 1 wherein the indication of the proof of purchase of the second work is sent from, or includes an indication of affiliation with, a first consumer device.

3. The method of claim 1 wherein the indication of the proof of purchase of the second work includes an indication of affiliation with a first consumer device, and wherein the authorization is sent to a second consumer device.

4. The method of claim 1 wherein the indication of the proof of purchase of the second work includes data captured by an optical device.

5. The method of claim 4 wherein the data captured by the optical device has been recognized by a recognition process and transformed into a human readable format, and wherein at least a portion of the indication of the proof of purchase of the second work is in a human readable format.

6. The method of claim 1 wherein the second work was purchased from a first distributor, and wherein sending authorization for access to the electronic copy of the first work when the determination is successful includes sending the authorization for access to a second distributor.

7. The method of claim 1 wherein the electronic copy of the first work is an electronic copy of a work unrelated to the second work.

8. The method of claim 1 wherein the determining whether the proof of purchase of the second work corresponds to a portion of the request for access to the electronic copy of the first work includes determining a number of times of receiving an equivalent request for access to the electronic copy of the first work.

9. The method of claim 1 wherein the authorization for access to the electronic copy of the first work includes a portion that is time-restrictive.

10. The method of claim 1 wherein the indication of the proof of purchase includes a semi-unique portion corresponding to the second work, and wherein the indication of the proof of purchase includes a unique portion corresponding to a first consumer device associated with a copy of the second work.

11. A device comprising:
a processor;
a memory configured with instructions for causing the processor to perform a method, the method comprising:
obtaining a proof of purchase for a first work;
sending the proof of purchase for the first work;
receiving an authorization for an electronic copy of a work;
sending at least a portion of the authorization for the electronic copy of the work; and
receiving at least a portion of the electronic copy of the work.

12. The device of claim 12, wherein the obtaining the proof of purchase includes obtaining an electronic copy of a receipt and deriving the proof of purchase from one or more isolated portions of the electronic copy of the receipt.

13. The device of claim 12, wherein the device further comprises an optical capture component, and wherein the electronic copy of the receipt is captured with the optical capture component.

14. The device of claim 12, wherein the obtaining the proof of purchase further includes matching information from the one or more isolated portions of the electronic copy of the receipt with data of or associated with the first work.

15. A method for requesting access to an electronic copy of a first work, the method comprising:
obtaining a proof of purchase for an electronic copy of a second work;
sending the proof of purchase of the electronic copy of the second work;
sending a request for the electronic copy of the first work, wherein the request for the electronic copy of the first work includes an identifier associated with the proof of purchase; and
receiving at least a portion of the electronic copy of the second work based at least in part on an outcome of a determination associated with the request for the electronic copy of the first work.

16. The method of claim 15, wherein the method further comprises:
receiving an authorization for the electronic copy of the first work after sending the request for the electronic copy of the first work; and
sending at least a portion of the authorization for the electronic copy of the first work before receiving at least a portion of the electronic copy of the second work.

17. The method of claim 15 wherein the first work and the second work are the same work.

18. The method of claim 15 wherein the obtaining proof of purchase for the electronic copy of the second work includes isolating a portion of an electronic copy of a receipt and obtaining at least a portion of the proof of purchase from the isolated portion of the electronic copy of the receipt.
